(19) United States
(12) Patent Application Publication
(10) Pub. No.: US 2015/0202665 A1
(43) Pub. Date: Jul. 23, 2015

(54) COOLING DEVICE CLEANING SYSTEM FOR CONSTRUCTION MACHINE

(71) Applicants: Dong-Myoung Choi, Busan (KR); Sung-Hwan Shin, Changwon-si (KR)

(72) Inventors: Dong-Myoung Choi, Busan (KR); Sung-Hwan Shin, Changwon-si (KR)

(73) Assignee: VOLVO CONSTRUCTION EQUIPMENT AB, Eskilstuna (SE)

(21) Appl. No.: 14/424,204

(22) PCT Filed: Sep. 4, 2012
(86) PCT No.: PCT/KR2012/007075

§ 371 Date: Feb. 26, 2015

(51) Int. Cl. B08B 5/04

(52) U.S. Cl. CPC B08B 5/04

(57) ABSTRACT

A cleaning system of a cooling device for a construction machine is disclosed, which includes a moving body mounted on a cooling device core of the construction machine and having a suction unit beating and sucking pollution materials formed on a front surface of the cooling device core and a dust collection portion storing the pollution materials sucked by the suction unit. The cleaning system of a cooling device for a construction machine includes the suction unit installed on the front surface of the cooling device core to beat and suck the pollution materials formed on the cooling device core, a unit driving portion moving the suction unit upward and downward on the front surface of the cooling device core, the dust collection portion storing the pollution materials sucked by the suction unit, and a suction pipe connecting the suction unit and the dust collection portion with each other.

### TECHNICAL FIELD

The present invention relates to a cleaning system of a cooling device for a construction machine, and more particularly, to a cleaning system of a cooling device for a construction machine, which includes a moving body mounted on a cooling device core of the construction machine and having a suction unit beating and sucking pollution materials formed on a front surface of the cooling device core and a dust collection portion storing the pollution materials sucked by the suction unit.

### BACKGROUND OF THE INVENTION

In a vehicle, a cooling device is installed to cool an engine and the like. One of basic cooling methods for such a cooling device is an air cooling type cooling method through a contact with atmosphere. In this case, a large amount of outdoor air may be sucked by a cooling fan or the like to heighten a cooling effect. In the case of the clean atmosphere, no particular problem may occur, whereas in the case of a construction machine that is used in construction spot, the construction machine may be exposed to a lot of dust or impurities included in the atmosphere to cause a problem. That is, many pollution materials, such as dust, moisture, and flue gas, may be attached to the cooling device to cause deterioration of the cooling efficiency. Accordingly, it is separately required to remove such pollution materials.

An apparatus that can perform cleaning work to remove pollution materials has been devised, and an example thereof is disclosed in Korean Unexamined Patent Publication No. 10-2011-0063106 entitled “Radiator cleaning apparatus of a cooling module for a vehicle”.

This invention is to remove foreign substances that exist in a main body of a cooling device core with high-pressure air, and includes an air spray unit, which is mounted between the main body of the cooling device core and a radiator and is installed to be connected to an air tank provided in a vehicle to spray high-pressure air to the front side of the main body of the cooling device core.

According to this invention, however, in beating the dust using air that spouts from the spray unit positioned on both side portions of the cooling device core, spray regions are limited, and thus spray force may not properly act on the center portion of the cooling device core. Further, since cleaning apparatus operates in an air spray type, the beaten dust may pollute a peripheral portion or may be attached to the cooling device core again resulting in the pollution materials may not be processed cleanly. In addition, a plurality of nozzles that are installed on the spray unit may operate to provide different spray forces.

On the other hand, Japanese Unexamined Patent Publication No. 2003-194493 discloses “Radiator cleaning apparatus”.

According to this invention, in a vehicle that is provided with a radiator for cooling a cooling device core with outdoor air that passes through the cooling device core and a spring brake system for parking, a plurality of nozzles for spurting compressed air from the rear of the radiator toward the cooling device core are arranged to supply compressed air of a spring brake chamber for parking.

This invention is different from the above-described invention on the point that pressure of the brake chamber is utilized, but is the same as the above-described invention on the point that it operates in an air spray type using the spray nozzles and thus may pollute the peripheral portion. Further, this invention has a limit that a plurality of spray nozzles are connected to one tube and the respective spray nozzles operate to provide different spray forces.

Accordingly, in a cleaning system that cleans the front portion of the cooling device core, it is necessary to operate suction nozzles rather than the spray nozzles and it is necessary to constantly maintain suction forces of the suction nozzles. Further, since there is a limit in removing the pollution materials using only the suction forces of the nozzles, it is necessary to provide an auxiliary constituent element, such as a brush.

### SUMMARY OF THE INVENTION

Accordingly, the present invention has been made to solve the aforementioned problems occurring in the prior art, and it is an object of the present invention to provide a cleaning system of a cooling device for a construction machine, which includes a unit driving portion mounted on the cooling device applied to the construction machine and having a suction unit beating and sucking pollution materials formed on a front surface of a cooling device core to perform cleaning work uniformly with respect to the front surface of the cooling device, and a dust collection portion storing the pollution materials sucked by the suction unit to prevent the pollution materials from being dispersed to a peripheral portion.

Another object of the present invention is to provide a cleaning system of a cooling device for a construction machine, in which a pair of brushes is attached to upper and lower portions of a suction nozzle of the suction unit to increase an ability of removing the pollution materials on the front surface of the cooling device core, and a plurality of suction inlets are formed on the suction nozzle to provide constant suction force.

### TECHNICAL SOLUTION

To achieve the above objects, in accordance with an embodiment of the present invention, there is provided a cleaning system of a cooling device for a construction machine, the cleaning system including: a suction unit installed on a front surface of a cooling device core to beat and suck pollution materials formed on the cooling device core; a unit driving portion moving the suction unit upward and downward on the front surface of the cooling device core; a dust collection portion storing the pollution materials sucked by the suction unit; and a suction pipe connecting the suction unit and the dust collection portion with each other.

The suction unit may include a suction nozzle having coupling projections formed on upper and lower portions of the suction nozzle along a length direction thereof; and a brush having a coupling groove formed on one side surface thereof in a length direction thereof to be detachably fitted into the coupling projections, wherein the suction nozzle has a plurality of suction inlets formed on a surface thereof that faces the front surface of the cooling device core, and is coupled to the suction pipe, which is connected to the dust collection portion, through one side surface thereof, and the brush has brush hair formed on a surface thereof that faces the front surface of the cooling device core.

Further, the suction inlets which are formed on a side of an end portion of the suction pipe have larger areas than the suction inlets which are formed on a side of the suction pipe and are coupled to the suction pipe, and the brush hair is formed to project with respect to a surface on which the plurality of suction inlets are formed.

Further, the unit driving portion may include a support bracket mounted on the front surface of the cooling device core, and having length grooves formed on both sides thereof in upward and downward directions and a rack rail formed on one end portion thereof in the upward and downward directions; a driven gear connected to the rack rail; and a driving motor connected to the driven gear.

Further, the dust collection portion may include a suction fan supplying a suction force to the suction unit through the suction pipe; an air discharge pipe separating and discharging air entering through the suction fan together with the pollution materials; and a dust collection box storing the pollution materials sucked through the suction unit, the suction pipe, and the suction fan.

On the other hand, the cleaning system according to the aspect of the present invention may further include a control unit controlling upward and downward movement of the suction unit and an operation of the suction fan.

Here, the control unit may include a switch installed on one side of a cab.

### ADVANTAGEOUS EFFECT

The cleaning system of a cooling device for a construction machine in accordance with an embodiment of the present invention as constructed above has the following advantages.

The moving body includes the suction unit beating and sucking the pollution materials formed on the front surface of the cooling device core, and thus the cleaning work can be uniformly performed with respect to the front surface of the cooling device. In addition, the dust collection portion stores the pollution materials sucked by the suction unit, and thus the pollution materials can be prevented from being dispersed to the peripheral portion.

Further, since a pair of brushes is detachably attached to the upper and lower portions of the suction nozzle of the suction unit, the cleaning performance of the front surface of the cooling device core can be improved, and the maintenance and repair of the brushes can be facilitated.

In addition, the suction nozzle having a plurality of suction inlets formed thereon to heighten the suction pressure is formed so that the size of the suction inlet becomes larger as going from the suction pipe side to the end portion, and thus the suction forces of the respective suction inlets can be constantly maintained.

### BRIEF DESCRIPTION OF THE DRAWINGS

The above objects, other features and advantages of the present invention will become more apparent by describing the preferred embodiments thereof with reference to the accompanying drawings, in which:

FIG. 1 is a perspective view of a cleaning system of a cooling device for a construction machine according to an embodiment of the present invention;

FIG. 2 is a cross-sectional view of FIG. 1;

FIG. 3 is a rare view of a moving body according to an embodiment of the present invention;

FIG. 4 is a perspective view of a suction unit according to an embodiment of the present invention;

FIG. 5 is an exploded perspective view of FIG. 4;

FIG. 6 is a cross-sectional view taken along line A-A of FIG. 4;

FIG. 7 is a right side cross-sectional view of the moving body of FIG. 1; and

FIG. 8 is a left side cross-sectional view of the moving body of FIG. 1.

### DETAILED DESCRIPTION OF THE INVENTION

Now, preferred embodiments of the present invention will be described in detail with reference to the accompanying drawings. The matters defined in the description, such as the detailed construction and elements, are nothing but specific details provided to assist those of ordinary skill in the art in a comprehensive understanding of the invention, and the present invention is not limited to the embodiments disclosed hereinafter.

A cleaning system of a cooling device for a construction machine according to an embodiment of the present invention includes a suction unit installed on a front surface of a cooling device core 9 to beat and suck pollution materials formed on the cooling device core 9; a unit driving portion moving the suction unit upward and downward on the front surface of the cooling device core 9; a dust collection portion 2 storing the pollution materials sucked by the suction unit; and a suction pipe 5 connecting the suction unit and the dust collection portion 2 with each other.

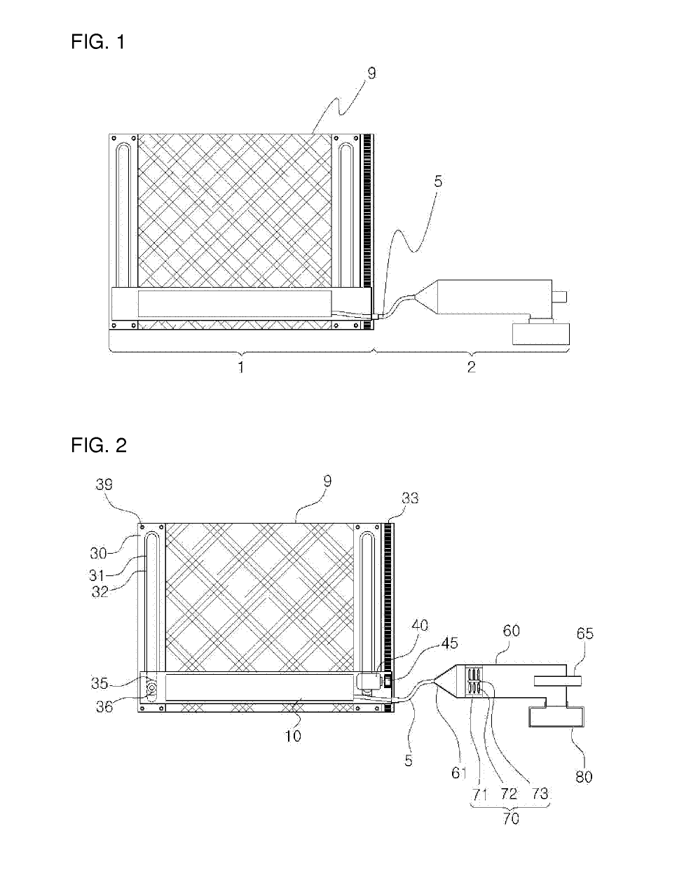

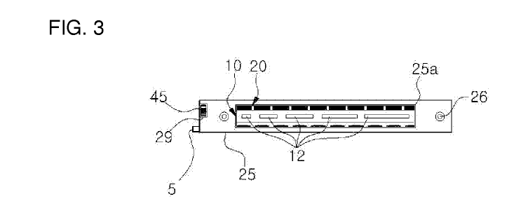

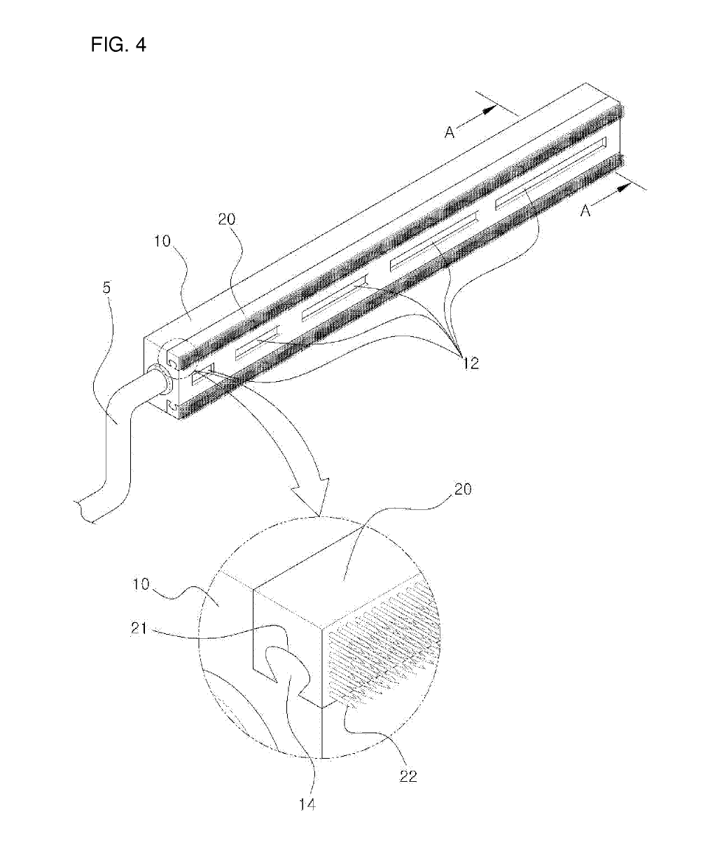

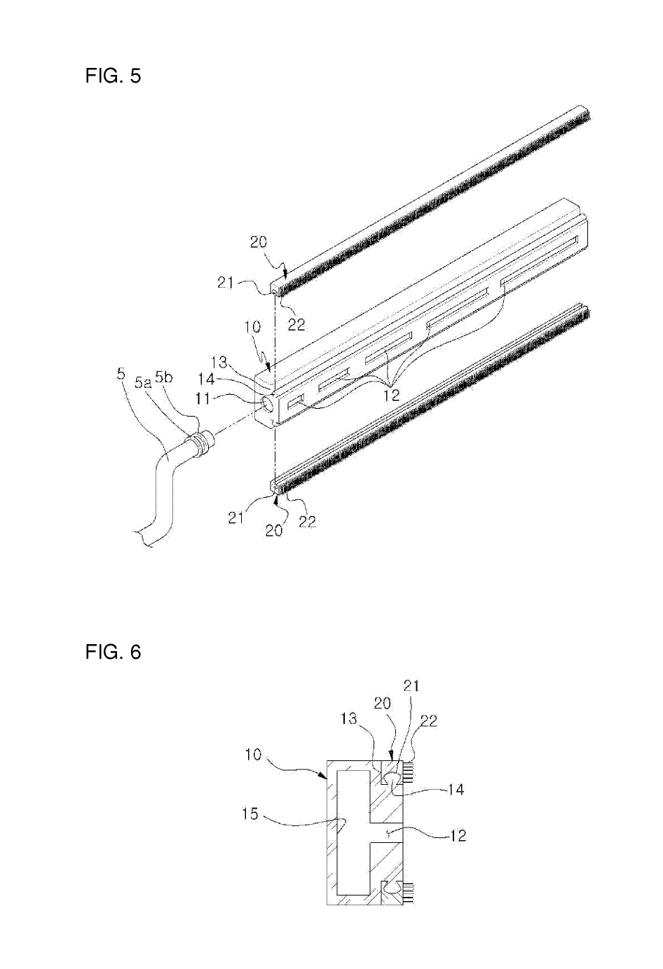

FIG. 1 is a perspective view of a cleaning system of a cooling device for a construction machine according to an embodiment of the present invention, and FIG. 2 is a cross-sectional view of FIG. 1. FIG. 3 is a rare view of a moving body according to an embodiment of the present invention. FIG. 4 is a perspective view of a suction unit according to an embodiment of the present invention, FIG. 5 is an exploded perspective view of FIG. 4, and FIG. 6 is a cross-sectional view taken along line A-A of FIG. 4.

FIG. 1 illustrates an example of a cleaning system of a cooling device for a construction machine according to the present invention. This cleaning system includes a moving body 1 coupled to a cooling device core 9 and moving upward and downward to beat and suck pollution materials on the front surface of the cooling device core 9, a dust collection portion 2, and a suction pipe 5 connecting the moving body 1 and the dust collection portion 2 with each other.

The moving body 1 includes a suction unit that is composed of a suction nozzle 10 and a brush 20, a main body 25 of the moving body, and a unit driving portion.

First, the suction unit will be described. The suction unit includes the brush 20 beating the pollution materials on the front surface of the cooling device core 9, and the suction nozzle 10 sucking the beaten pollution materials. The suction unit is mounted on the inside of the main body 25 of the moving body.

Referring to FIGS. 4 to 6, the main body of the suction nozzle 10 may be formed basically in an elongated cuboidal shape, and the cross-section thereof is not necessarily limited to a rectangle, but may be formed in a circular shape. The suction nozzle 10 is formed with a length enough to comprehend the horizontal width of the front surface portion of the cooling device core 9.

A hollow portion 15 is formed in the main body of the suction nozzle 10. As seen from the hollow portion 15, the main body of the suction nozzle 10 is formed so that the surface portion that faces the cooling device core 9 is thicker than other portions. In this portion, a suction inlet 12 and the brush 20 to be described later are coupled to each other.

The suction pipe 5 is coupled to one side surface of the suction nozzle 10. Since the suction nozzle 10 and the suction pipe 5 should be coupled to each other with airtight, they should be firmly coupled to each other. A through-hole 11 is formed on one side surface of the suction nozzle 10, and the suction pipe 5 is inserted into the through-hole 11. Insertion projections 5a and 5b are formed on the suction pipe 5 so that they are inserted into the through-hole 11 to be engaged with each other. The insertion projections 5a and 5b are formed of a flexible material and are fitted into the through-hole 11. For more accurate sealing process, a sealing member may be added between the insertion projections 5a and 5b and the through-hole 11, or the insertion projections 5a and 5b and the through-hole 11 may be coupled to each other by adhesives. Of course, in coupling the suction nozzle 10 and the suction pipe 5 to each other, any method, such as a method using screws and bolts, can be adopted so far as airtight is maintained.

A plurality of suction inlets 12 are formed on a surface of the suction nozzle 10 that faces the cooling device core 9. The suction inlet 12 is formed in the form of an elongated hole along the length direction thereof. Preferably, the plurality of suction inlets 12 are formed so that the suction area of the suction inlet that is formed on the side to which the suction pipe 5 is coupled is larger than the suction area of the suction inlet that is formed on the side of the end portion. This is to compensate for the suction force acting on the end portion, which is relatively weaker than the suction force acting on the side of the suction pipe 5, and detailed dimensions of the respective suction inlets 12 may be set theoretically or experimentally. Since the area of the suction inlet 12 that is formed on the end portion is larger than the area of the suction inlet 12 that is formed on the side of the suction pipe 5, the suction forces may be equally generated at the respective suction inlets 12.

On upper and lower end portions of the front surface of the suction nozzle 10, recessed grooves 13, in which the respective brushes 20 can be seated, are formed. The grooves 13 are formed along the length direction so that they are cut out with a predetermine depth on the front surface and the upper surface of the suction nozzle 10 and on the front surface and the lower surface of the suction nozzle 10.

On the other hand, coupling projections 14 are formed on one side surface of the recessed groove 13. The coupling projections 14 are formed along the length direction of the suction nozzle 10 on one side surface of the recessed groove 13. For a stable coupling, the coupling projections 14 are formed so that the thickness of the upper portion thereof is thicker than the thickness of the lower portion thereof.

The brush 20 is formed in a shape that corresponds to the cross-section of the recessed groove 13 formed on the suction nozzle 10, and the length of the brush 20 is equal to the length of the suction nozzle 10. A coupling groove 21 formed on one side surface of the brush 20. The coupling groove 21 is formed in a shape that corresponds to the coupling projection 14 of the suction nozzle 10. The brush 20 may be inserted by pushing one side surface thereof along the length direction of the suction nozzle 10 to match the coupling groove 21 with the coupling projection 14 of the suction nozzle 10 or may be fitted through force fitting. The brush 20 may be formed of rubber or plastic injection material having high thermal resistance.

On the surface that faces the cooling device core 9 of the brush 20, brush hair 22 gets stuck closely. It is preferable that the brush hair 22 is composed of hard and durable hairs that are used in a mechanical device.

It is preferable that the brush hair 22 is formed to stand at right angles toward the cooling device core 9. By doing so, uniform force can be applied when the cleaning system of the cooling device move upward and downward along the front surface portion of the cooling device core 9.

The brush hair 22 is formed to project from the surface of the suction inlet 12 formed on the suction nozzle 10. When the main body 25 of the moving body moves upward and downward on the front surface portion of the cooling device core 9, the brush hair 22 primarily beats the pollution materials that are attached to the front surface portion of the cooling device core 9. The beaten pollution materials are sucked through the suction inlet 12 of the suction nozzle 10 to be sucked into the suction pipe 5 through the hollow portion 15.

The brush 20 is detachably attached to the suction nozzle 10 to facilitate repair or exchange.

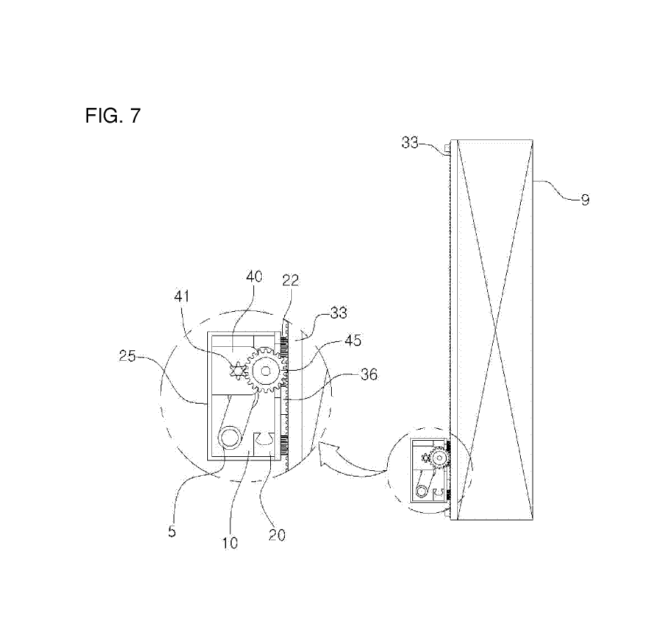

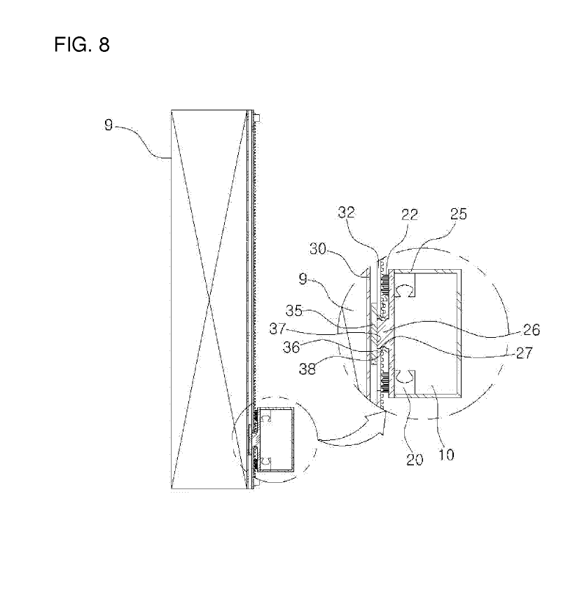

Now, the unit driving portion and the main body 25 of the moving body will be described mainly with reference to FIGS. 1, 2, 7, and 8.

The unit driving portion includes a support bracket 30 mounted on the cooling device core 9, a driving motor 40 providing driving force to the main body 25 of the moving body, and a driven gear 45 connected to the driving motor 40.

The support bracket 30 is formed with a length enough to comprehend the front surface portion of the cooling device core 9 and is installed on the front surface of the cooling device core 9. The support bracket 30 may be formed in a form that follows the circumference of the cooling device core 9, or may be separately formed on both side surfaces of the cooling device core 9 as shown in FIG. 1. The support bracket 30 is fastened to the cooling device core 9 through a screw 39.

Length grooves 31 are formed in the length direction on the support bracket 30. A curved portion 32 is convexly formed toward the front surface around the length grooves 31 to form a space therein. A support piece 35 is inserted into the curved portion 32.

The support piece 35 has a plate shape with a width enough to be inserted into the curved portion 32, and a pipe-shaped projection 36 is vertically formed in the center portion thereof. An accommodation groove 37 is formed on the center portion of the projection 36, and the main body 25 of the moving body to be described later is coupled thereto. A concave bent portion 38 is formed along the circumference on the upper portion of the projection 36.

On any one of support brackets 30, a rack rail 33 is formed in parallel to the length groove 31. A rack is formed on one side surface of the rack rail 33, and the rack rail 33 may be integrally formed with the support bracket 30, or may be formed as a separate component to be coupled to the support bracket 30.

The main body 25 of the moving body is formed in a cuboidal shape having a width enough to be connected to the support bracket 30 formed on left and right sides of the cooling device core 9, and is hollow. Of course, the main body 25 of the moving body may be formed in various shapes including the suction unit and the unit driving portion in addition to the basic shape.

On lower portions of both sides of the main body 25 of the moving body, cylindrical coupling projections 26 are formed to be inserted into the accommodation grooves 37 of the support pieces 35. A recessed groove portion 27 is formed along the circumference on a part of the coupling projection 26, and is force-fitted into the bent portion 38 of the accommodate groove 37 not to easily secede from the bent portion 38 when the coupling projection 26 is inserted into the accommodation groove 37. The main body 25 of the moving body is coupled to the support bracket 30 on the intervention of the support piece 35, and thus can move upward and downward to slide along the length groove 31 of the support bracket 30 (although it is exemplified that the main body 25 of the moving body and the support bracket 30 are coupled to each other through coupling by the projection and groove, the coupling between the main body 25 of the moving body and the support bracket 30 may be performed through various known coupling methods).

On the front surface portion of the main body 25 of the moving body, an opening 25a is formed, and the brush 20 of the suction unit is mounted so that the surface on which the brush 20 is formed projects.

The driving motor 40 is mounted on one side of the main body 25 of the moving body, i.e., on the side where the rack rail 33 is formed. A general DC motor that can perform forward and reverse rotation may be used as the driving motor 40. Of course, a reduction gear may also be used. A driving gear 41 is formed on a shaft of the driving motor 40, and a driven gear 45 is connected to the driving gear 41. The driven gear 45 is fixed to the inner side wall of the main body 25 of the moving body to serve to reduce the speed of the driving motor 40 according to a gear ratio of the driving gear 41 and the driven gear 45.

The driven gear 45 partially project through a groove formed on the main body 25 of the moving body and is engaged with the rack rail 33. The driven gear 45 is fixed to an appropriate position on the inner side wall of the main body 25 of the moving body so that the driven gear 45 is engaged with the rack rail 33, and the driven gear 45 ascends or descends along the upper portion of the rack rail 33 according to the driving force of the driving motor 40. Accordingly, the main body 25 of the moving body entirely ascends and descends along the rack rail 33.

The dust collection portion 2 will be described with reference to FIG. 2.

The dust collection portion 2 includes a cylindrical main body 60, a suction fan 70 generating a suction force, an air discharge pipe 65 separating air from a mixture of sucked air and pollution materials to discharge the air, and a dust collection box 65 in which the pollution materials are accumulated.

The main body 60 of the dust collection portion 2 is formed entirely in a cylindrical shape. An opening 61 is formed on one side of the main body 60 and the suction pipe 5 is connected thereto.

The suction fan 70 is mounted on the side of the opening 61 in the main body 60. The suction fan 70 includes an external body 71, a rotating wing 72, and a conical center body 73 that forms the center portion of the rotating wind 72. The suction fan 70 provides a suction force to the suction nozzle 10 of the suction unit, and should be set with sufficient capacity. The rotating wing 72 is formed as a curved surface in a screw shape to suck the mixture of air and pollution materials and to convert a centrifugal force into a rotating force.

The mixture of air and pollution materials, which is sucked by the suction unit through the suction pipe 5 and the suction fan 70, is rotated in whirls along the inside of the main body 60 of the dust collection portion 2 to move. In this case, the mixture of air and pollution materials is separated by the centrifugal force, and the pollution materials that are relatively weighted move along the inner side wall of the main body 60 while the air that is relatively light moves along the center portion of the main body 60. The air that moves along the center portion of the main body 60 is discharged to an outside along an air discharge pipe 65 that is connected to an outside of the main body 60.

The pollution materials that move along the inner side wall of the main body 60 are collected and accumulated in a dust collection box 80 installed on a lower portion on the other side of the main body 60.

A power for driving the driving motor 40 and the suction fan 70 may be provided from one of various power supplies existing in the vehicle. Since this is a general term, separate explanation thereof will be omitted. However, the driving force of the suction fan 70 may be provided using compressed air of the air suction portion in the engine of the vehicle in addition to the electric power.

The control unit will be described (the control unit is not separately illustrated).

The control unit controls the operations of the driving motor 40 of the unit driving portion and the suction fan 70 of the dust collection portion 2, and may simply supply or intercept electricity by a switch. The switch may be installed in a cab so that the switch can be manually used. Further, the start and end times and operation intervals of the switch may be set so that the switch can be automatically controlled by a program. For this, a PCB control board that contains a separate program or software may be installed, or the existing control related unit, such as ECU, may be set to include the above-described operational features.

The operation of the cleaning system of a cooling device for a construction machine according to an embodiment of the present invention will be described.

If the driving motor 40 is operated, the rotating force of the driving gear 41 of the driving motor 40 is transferred to the driven gear 45, and the driven gear 45 is rotated on the rack rail 33 to make the main body 25 of the moving body move upward and downward on the front surface of the cooling device core 9. As the main body 25 of the moving body moves, the brush 20 of the suction unit beats the pollution materials that are attached to the front surface of the cooling device core 9.

At the same time, if the suction fan 70 operates, a suction force is applied to the suction nozzle 10 of the suction unit through the suction pipe 5 to suck the pollution materials that are beaten from the front surface of the cooling device core 9. The pollution materials that are sucked to the suction nozzle 10 are stored in the dust collection box 80 through the suction pipe 5 and the suction fan 70.

Although the invention has been described with reference to the preferred embodiments in the attached figures, it is noted that equivalents may be employed and substitutions made herein without departing from the scope of the invention as recited in the claims.

### INDUSTRIAL APPLICABILITY

In accordance with the present invention as constructed above, the moving body includes the suction unit beating and sucking the pollution materials formed on the front surface of the cooling device core, and thus the cleaning work can be uniformly performed with respect to the front surface of the cooling device. In addition, the dust collection portion stores the pollution materials sucked by the suction unit, and thus the pollution materials can be prevented from being dispersed to the peripheral portion.

Further, since a pair of brushes is detachably attached to the upper and lower portions of the suction nozzle of the suction unit, the cleaning performance of the front surface of the cooling device core can be improved, and the maintenance and repair of the brushes can be facilitated.

In addition, the suction nozzle having a plurality of suction inlets formed thereon to heighten the suction pressure is formed so that the size of the suction inlet becomes larger as going from the suction pipe side to the end portion, and thus the suction forces of the respective suction inlets can be constantly maintained.

While the present invention has been described in connection with the specific embodiments illustrated in the drawings, they are merely illustrative, and the invention is not limited to these embodiments. It is to be understood that various equivalent modifications and variations of the embodiments can be made by a person having an ordinary skill in the art without departing from the spirit and scope of the present invention. Therefore, the true technical scope of the present invention should not be defined by the above-mentioned embodiments but should be defined by the appended claims and equivalents thereof.

1. A cleaning system of a cooling device for a construction machine having a cooling device core, comprising:
a suction unit installed on a front surface of the cooling device core to beat and suck pollution materials formed on the cooling device core;
a unit driving portion moving the suction unit upward and downward on the front surface of the cooling device core;
a dust collection portion storing the pollution materials sucked by the suction unit; and
a suction pipe connecting the suction unit and the dust collection portion with each other.

2. The cleaning system according to claim 1, wherein the suction unit comprises:
a suction nozzle having coupling projections formed on upper and lower portions of the suction nozzle along a length direction of the suction nozzle; and
a brush having a coupling groove formed on one side surface thereof in a length direction to be detachably fitted into the coupling projections,
wherein the suction nozzle has a plurality of suction inlets formed on a surface thereof that faces the front surface of the cooling device core, and is coupled to the suction pipe, which is connected to the dust collection portion, through one side surface thereof, and
the brush has brush hair formed on a surface thereof that faces the front surface of the cooling device core.

3. The cleaning system according to claim 2, wherein the suction inlets which are formed on a side of an end portion of the suction pipe have larger areas than the suction inlets which are formed on a side of the suction pipe and are coupled to the suction pipe, and
the brush hair is formed to project with respect to a surface on which the plurality of suction inlets are formed.

4. The cleaning system according to claim 1, wherein the unit driving portion comprises:
a support bracket mounted on the front surface of the cooling device core, and having length grooves formed on both sides thereof in upward and downward directions and a rack rail formed on one end portion thereof in the upward and downward directions;
a driven gear connected to the rack rail; and
a driving motor connected to the driven gear.

5. The cleaning system according to claim 1, wherein the dust collection portion comprises:
a suction fan supplying a suction force to the suction unit through the suction pipe;
an air discharge pipe separating and discharging air entering through the suction fan together with the pollution materials; and
a dust collection box storing the pollution materials sucked through the suction unit, the suction pipe, and the suction fan.

6. The cleaning system according to claim 1, further comprising a control unit controlling upward and downward movement of the suction unit and an operation of the suction fan.

7. The cleaning system according to claim 6, wherein the control unit comprises a switch installed on one side of a cab.

8. The cleaning system according to claim 2, further comprising a control unit controlling upward and downward movement of the suction unit and an operation of the suction fan.

9. The cleaning system according to claim 3, further comprising a control unit controlling upward and downward movement of the suction unit and an operation of the suction fan.

10. The cleaning system according to claim 4, further comprising a control unit controlling upward and downward movement of the suction unit and an operation of the suction fan.

11. The cleaning system according to claim 5, further comprising a control unit controlling upward and downward movement of the suction unit and an operation of the suction fan.

12. The cleaning system according to claim 8, wherein the control unit comprises a switch installed on one side of a cab.

13. The cleaning system according to claim 9, wherein the control unit comprises a switch installed on one side of a cab.

14. The cleaning system according to claim 10, wherein the control unit comprises a switch installed on one side of a cab.

15. The cleaning system according to claim 11, wherein the control unit comprises a switch installed on one side of a cab.
